(19) United States
(12) Patent Application Publication
(10) Pub. No.: US 2026/0012718 A1
(43) Pub. Date: Jan. 8, 2026

(54) Camera Assembly with Audio-Based Verification Feature

(71) Applicant: Roku, Inc., San Jose, CA (US)

(72) Inventors: Bruce Benson, Yaxley (GB); Gordon Downie, Cambridge (GB); Michael Smith, Histon (GB); Greg Garner, Key Colony Beach, FL (US)

(21) Appl. No.: 18/763,571

(22) Filed: Jul. 3, 2024

(51) Int. Cl. H04R 1/02; H04N 23/11; H04N 23/51; H04N 23/667; H04N 23/71

(52) U.S. Cl. CPC H04R 1/028; H04N 23/11; H04N 23/51; H04N 23/667; H04N 23/71; H04R 2499/11

(57) ABSTRACT

In one aspect, an example method can be used with a camera assembly comprising a movable component, a triggering mechanism, and a microphone. The method includes causing the triggering mechanism to attempt to move the movable component; proximate a time point of the attempt to move the movable component, capturing, via the microphone, audio data; determining whether the captured audio data satisfies a condition; and in response to determining whether the captured audio data satisfies the condition, performing an action related to the moveable component and/or the triggering mechanism.

### USAGE AND TERMINOLOGY

In this disclosure, unless otherwise specified and/or unless the particular context clearly dictates otherwise, the terms “a” or “an” mean at least one, and the term “the” means the at least one.

### SUMMARY

In one aspect, an example method for use with a camera assembly comprising a movable component, a triggering mechanism, and a microphone is disclosed. The method includes: causing the triggering mechanism to attempt to move the movable component; proximate a time point of the attempt to move the movable component, capturing, via the microphone, audio data; determining whether the captured audio data satisfies a condition; and in response to determining whether the captured audio data satisfies the condition, performing an action related to the moveable component and/or the triggering mechanism.

In another aspect, an example camera assembly is disclosed. The camera assembly includes a movable component, a triggering mechanism, a microphone, and a controller. The controller is configured to perform a set of operations including: causing the triggering mechanism to attempt to move the movable component; proximate a time point of the attempt to move the movable component, capturing, via the microphone, audio data; determining whether the captured audio data satisfies a condition; and in response to determining whether the captured audio data satisfies the condition, performing an action related to the moveable component and/or the triggering mechanism.

In another aspect, a non-transitory computer-readable medium is disclosed. The non-transitory computer-readable medium has stored thereon program instructions that upon execution by a processor, cause performance of a set of operations including: causing the triggering mechanism to attempt to move the movable component; proximate a time point of the attempt to move the movable component, capturing, via the microphone, audio data; determining whether the captured audio data satisfies a condition; and in response to determining whether the captured audio data satisfies the condition, performing an action related to the moveable component and/or the triggering mechanism.

### BRIEF DESCRIPTION OF THE DRAWINGS

FIG. 1 is a simplified block diagram of an example camera assembly in which various described principles can be implemented.

FIG. 2 is a simplified block diagram of an example computing system in which various described principles can be implemented.

FIG. 3A is a diagram that illustrates an example camera assembly in a first example state in which various described principles can be implemented.

FIG. 3B is a diagram that illustrates an example camera assembly in a second example state in which various described principles can be implemented.

FIG. 4 is a flow chart of an example method.

FIG. 5 is a flow chart of another example method.

FIG. 6 is a flow chart of another example method.

### DETAILED DESCRIPTION

### I. Overview

Camera sensors are particularly sensitive to light in the infrared wavelengths of the electromagnetic spectrum. Thus, in connection with operating camera assemblies and other camera devices, infrared (IR) filters are sometimes used to either pass or remove infrared light, to help improve the quality of the resulting captured photograph. For example, an IR pass filter may be used to filter out light wavelengths below 720 nanometers (thus, the visible light spectrum). One common application for such a filter is in thermal imaging cameras that allow for effective use in low-light environments.

In some situations, a camera assembly may have an IR filter that is configured to move between an active position (in place over a camera sensor, for example) and an inactive position (away from the camera sensor), such that the IR filter can be used when desired, and not used when not desired. The camera assembly can further include an electromagnet that can cause the IR filter to move between the active position and the inactive position.

For various reasons, it might be useful for a camera assembly to detect whether an IR filter has moved from one position to another. As one approach to detecting this, a physical IR filter switch on the exterior of a camera assembly or device might be used. However, this may not be desirable for various reasons. For example, this may be expensive and may take up too much space in the camera assembly. As another approach, the camera assembly can analyze the captured photograph to determine its IR values. But this may likewise not be desirable for various reasons. For example, this may be computationally intensive/expensive.

Disclosed herein are alternative techniques that can allow a camera assembly to detect whether an IR filter (or another movable component) has moved from position to another. More specifically, according to one example implementation, an example method for use with a camera assembly comprising a movable component (e.g., an IR filter), a triggering mechanism (e.g., an electromagnet), and a microphone is disclosed. The method includes: causing the triggering mechanism to attempt to move the movable component; proximate a time point of the attempt to move the movable component, capturing, via the microphone, audio data; determining whether the captured audio data satisfies a condition; and in response to determining whether the captured audio data satisfies the condition, performing an action related to the moveable component and/or the triggering mechanism.

These and related operations, systems, and features will now be described in greater detail.

### II. Example Architecture

### A. Camera Assembly

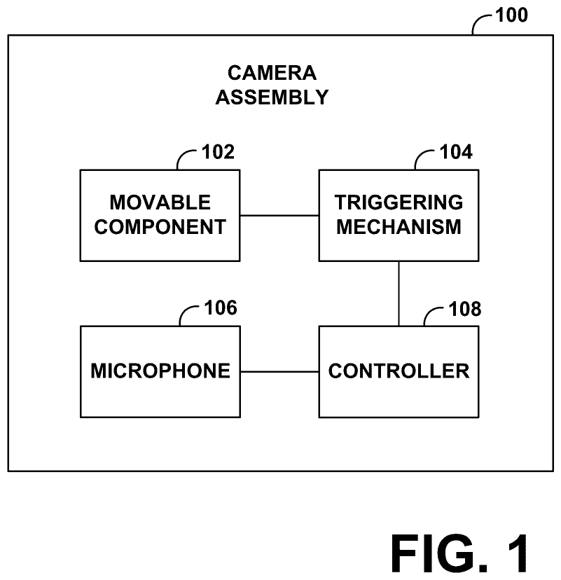

FIG. 1 is a simplified block diagram of an example camera assembly 100. As shown, the camera assembly 100 can include various components, such as a movable component 102, a triggering mechanism 104, a microphone 106, and a controller 108.

The camera assembly 100 can also include one or more connection mechanisms that connect various components within the camera assembly 100. For example, the camera assembly 100 can include the connection mechanisms represented by lines connecting components of the camera assembly 100, as shown in FIG. 1.

In this disclosure, the term “connection mechanism” means a mechanism that connects and facilitates communication between two or more components, devices, systems, or other entities. A connection mechanism can be or include a relatively simple mechanism, such as a cable or system bus, and/or a relatively complex mechanism, such as a packet-based communication network (e.g., the Internet). In some instances, a connection mechanism can be or include a non-tangible medium, such as in the case where the connection is at least partially wireless. In this disclosure, a connection can be a direct connection or an indirect connection, the latter being a connection that passes through and/or traverses one or more entities, such as a router, switcher, or other network device. Likewise, in this disclosure, a communication (e.g., a transmission or receipt of data) can be a direct or indirect communication.

In some embodiments, the camera assembly 100 can include other components, such as a camera sensor or other device capable of and/or that facilitates capturing photographs and/or other media content (perhaps including audio and/or video content).

Media content can be represented digitally by media data (e.g., image, video, and/or audio data), which can be generated, stored, and/or organized in various ways and according to various formats and/or protocols, using any related techniques now known or later discovered. Image data can also be stored and/or organized in various ways. For example, image data can be stored in various digital file formats, such as the Portable Network Graphics (PNG), JPG format, and the MPEG-4 format, among numerous other possibilities.

Returning to the camera assembly 100, this can include various components, such as a movable component 102, a triggering mechanism 104, a microphone 106, and a controller 108, as noted above.

The movable component 102 can take various forms. For example, the moveable component can be or include an infrared (IR) filter, or any other type of filter suitable for use with camera assemblies now known or later discovered.

The movable component 102 can move between two or more positions. For instance, in the above example where the movable component is an IR filter, the IR filter can move between an active position (in place over a camera sensor, for example) and an inactive position (away from the camera sensor). The motion of the movable component 102 can be linear, rotational, rotary, or oscillating, among other possibilities.

The triggering mechanism 104 can move (or attempt to move) the movable component 102. For example, the triggering mechanism could be a latch, a spring, or other mechanical component configured to cause motion. In some embodiments, the triggering mechanism could be an electronically-activated component, such as an electric motor configured to move the movable component 102 or an electromagnet. In the example of an electromagnet, it can to attract the movable component when the electromagnet is energized and release the movable component when the electromagnet is not energized.

The camera assembly 100 can includes other components, such as a housing. In such cases, the movable component 102, the triggering mechanism 104, and/or the microphone can be mounted to the housing. In some embodiments, the camera assembly 100 can include and be powered by a battery. Additionally or alternatively, the camera assembly 100 can be powered by an AC power source.

The camera assembly 100 can also take various forms. For example, the camera assembly can be a standalone camera device, or integrated into another device, such as a television or set-top box.

Generally, when the triggering mechanism 104 causes movement of the movable component 102, a sound is produced, which may be a “click” or related sound of the movable component moving from one position to another. Such a sound may be picked up by the microphone 106. In the example above where the movable component 102, triggering mechanism 104, and microphone 106 are mounted within a housing, the sound produced by the movable component 102 and triggering mechanism 104 could be loud from the perspective of the microphone. This could make the sound easier to detect and distinguish from other noise that may exist in the surrounding environment of the camera assembly 100.

The microphone 106 can pick up incoming audio by way of capturing associated audio data. The microphone can be mounted within the same housing as other components of the camera assembly 100. However, in some embodiments, the microphone 106 can be a separate device and connected to the camera assembly 100 via a connection mechanism as described above. Once captured, audio data from the microphone 106 may be transmitted to the controller 108 and/or another component for further operations.

In one example, the controller 108 can control the operations of other components within the camera assembly 100. In some embodiments, the controller may be connected to the triggering mechanism 104 and the microphone 106.

The controller 108 and/or components thereof may take the form of a computing system, an example of which is described below. In some embodiments, the camera assembly 100 may include multiple instances of at least some of the described components.

### B. Computing System

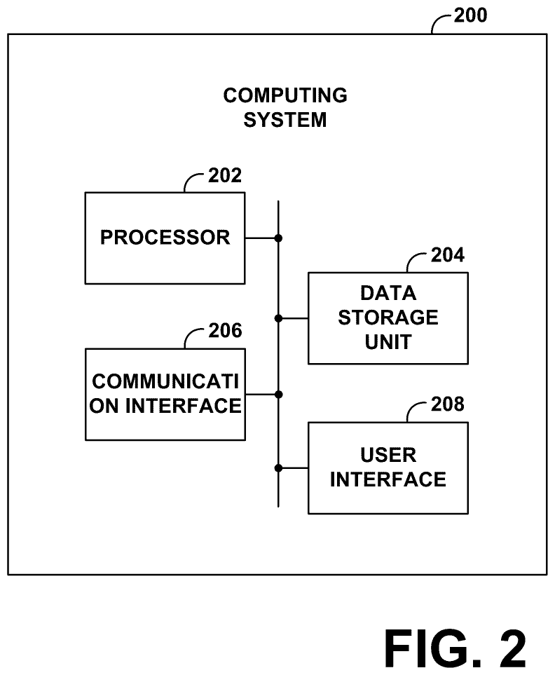

FIG. 2 is a simplified block diagram of an example computing system 200. The computing system 200 can be configured to perform and/or can perform one or more operations, such as the operations described in this disclosure. The computing system 200 can include various components, such as a processor 202, a data-storage unit 204, a communication interface 206, and/or a user interface 208.

The processor 202 can be or include a general-purpose processor (e.g., a microprocessor) and/or a special-purpose processor (e.g., a digital signal processor). The processor 202 can execute program instructions included in the data-storage unit 204 as described below.

The data-storage unit 204 can be or include one or more volatile, non-volatile, removable, and/or non-removable storage components, such as magnetic, optical, and/or flash storage, and/or can be integrated in whole or in part with the processor 202. Further, the data-storage unit 204 can be or include a non-transitory computer-readable storage medium, having stored thereon program instructions (e.g., compiled or non-compiled program logic and/or machine code) that, upon execution by the processor 202, cause the computing system 200 and/or another computing system, and/or another system to perform one or more operations, such as the operations described in this disclosure. These program instructions can define, and/or be part of, a discrete software application.

In some instances, the computing system 200 can execute program instructions in response to receiving an input, such as an input received via the communication interface 206 and/or the user interface 208. The data-storage unit 204 can also store other data, such as any of the data described in this disclosure.

The communication interface 206 can allow the computing system 200 to connect with and/or communicate with another entity according to one or more protocols. Therefore, the computing system 200 can transmit data to, and/or receive data from, one or more other entities according to one or more protocols. In one example, the communication interface 206 can be or include a wired interface, such as an Ethernet interface, a High-Definition Multimedia Interface (HDMI), or a Universal Serial Bus (USB) interface. In another example, the communication interface 206 can be or include a wireless interface, such as a cellular, Bluetooth, or Wi-Fi interface.

The user interface 208 can allow for interaction between the computing system 200 and a user of the computing system 200. As such, the user interface 208 can be or include an input component such as a keyboard, a mouse, a remote controller, a microphone, and/or a touch-sensitive panel. The user interface 208 can also be or include an output component such as a display device (which, for example, can be combined with a touch-sensitive panel) and/or a sound speaker.

The computing system 200 can also include one or more connection mechanisms that connect various components within the computing system 200. For example, the computing system 200 can include the connection mechanisms represented by lines that connect components of the computing system 200, as shown in FIG. 2.

The computing system 200 can include one or more of the above-described components and can be configured or arranged in various ways. For example, the computing system 200 can be configured as a server and/or a client (or perhaps a cluster of servers and/or a cluster of clients) operating in one or more server-client type arrangements, for instance.

In some cases, the computing system 200 can take the form of a more specific type of computing system, such as a desktop computer, a laptop, a tablet, a mobile phone, a television, a set-top box, a content streaming stick, or various combinations thereof, among other possibilities.

### III. Example Operations

The camera assembly 100 and/or components thereof can be configured to perform and/or can perform one or more operations. Various example operations that the camera assembly 100 can perform, and related features, will now be described with reference to various figures.

To begin, the controller 108 can cause the triggering mechanism 104 to attempt to move the movable component 102. For context, the movable component 102 can be moved for a variety of different reasons. In the above example, where the movable component 102 is an IR filter, the filter may be moved to be in a position in front of a camera sensor such that only infrared light is allowed into the sensor. This may allow for “night-vision” or thermal image photographs and/or video, as described above.

As noted above, the controller 108 can cause the triggering mechanism 104 to attempt to move the movable component 102. The controller 108 can do this in response to various operations. For example, the controller 108 can do this in response to determining whether a light level of a surrounding area of the camera assembly satisfies a condition. For example, if the camera assembly is in an environment that is usually well-lit, but then the lights turn off, it may be desired that the camera assembly enter a mode suitable for operation in low-light conditions. Thus, the controller 108 can receive a communication (from a sensor or other suitable device) that the light level has dropped below a certain threshold, and thus cause the triggering mechanism 104 to attempt to move the movable component 102.

In another example, the controller 108 can cause the triggering mechanism 104 to attempt to move the movable component 102 in response to determining whether a time of day satisfies a condition. For instance, following the IR filter example from above, the controller 108 could determine if the time of day is before or after sunset or a specified time, and cause the triggering mechanism 104 to attempt to move the movable component 102 accordingly.

In another example, the controller 108 can cause the triggering mechanism 104 to attempt to move the movable component 102 in response in response to determining whether a particular geographic location of the camera assembly satisfies a condition. For instance, also following the IR filter example from above, the controller 108 could determine, using information from a GPS or other GNSS service, a location of the camera assembly 100. This may aid a determination of the time and/or light level as in the above examples. Following this, the controller 108 could then cause the triggering mechanism 104 to attempt to move the movable component 102 accordingly.

Proximate (e.g., at or near, perhaps within a few seconds or seconds) a time point of the attempt to move the movable component 102, the controller 108 can capture audio data via the microphone 106. As noted above, if the movable component 102 is successfully moved, then a “click” or related sound of the movable component 102 moving from one position to another position may be produced. This sound may then be picked up by the microphone for analysis to determine if the movable component 102 successfully moved or not. The movable component 102 may fail to move for a variety of reasons, such as due to being stuck, a mechanical connection failure with the triggering mechanism, or some other issue.

In some embodiments, the controller 108 capturing audio data via the microphone may occur responsive to the controller 108 causing the triggering mechanism 104 to attempt to move the movable component 102, for the same reasons as above. In some instances, the capturing of audio data can occur for a predetermined duration. Such a predetermined duration may be for the time period in which the “click” of the movable component is expected to be heard. For instance, the predetermined duration could be 100 to 200 milliseconds, though other durations are possible in other embodiments.

After capturing the audio data, the controller 108 can determine whether the captured audio data satisfies a condition. As above, this can involve the controller 108 analyzing the captured audio data to determine if the “click” or other sound was produced by the movable component 102. If present, the sound could be a sign that the movable component 102 was successfully moved; conversely, if the sound is not present, this could indicate that the movable component 102 could failed to have been moved by the triggering mechanism 104.

Following the example above, the controller 108 determining whether the capture audio data satisfies a condition could involve the controller 108 determining that the captured audio data does not exceed a predetermined threshold of audio volume. As noted above, in the example where the movable component 102, triggering mechanism 104, and microphone 106 are mounted within a housing, the sound produced by the movable component 102 and triggering mechanism 104 could be loud from the perspective of the microphone 106, and thus the predetermined threshold of audio volume could be set accordingly.

In some embodiments, the controller 108 determining whether the captured audio data satisfies a condition could involve determining that the captured audio data does not exceed a predetermined threshold extent of similarity to reference audio data. Determining similarity to reference audio data may be accomplished in a variety of ways. In some embodiments, it may be determined by providing the audio data to a trained machine-learning model. Such a trained machine-learning model may be configured to receive input audio data and generate a similarity score relating to a degree of similarity between the received input audio data and reference audio data. For instance, reference audio data may be one or more prior recordings of the movable component 102 or other related component of the camera assembly 100 moving. The machine learning-model may then output a generated similarity score or otherwise provide it to the controller or other component of the camera assembly.

In some embodiments, the controller 108 determining whether the captured audio data satisfies a condition could involve determining that the captured audio data exceeds a predetermined threshold of audio volume. As noted above, in the example where the movable component 102, triggering mechanism 104, and microphone 106 are mounted within a housing, the sound produced by the movable component 102 and triggering mechanism 104 would be loud from the perspective of the microphone 106, and thus the predetermined threshold of audio volume could be set accordingly.

In some embodiments, determining whether the audio data satisfies a condition can involve determining that the captured audio data exceeds a predetermined threshold extent of similarity to reference audio data. As noted above, determining similarity to reference audio data may be accomplished in a variety of ways, including the use of a trained machine-learning model. In some embodiments, the audio data may be compared to two different reference audio data samples—one relating to the movable component 102 moving to an active position and another relating to the movable component 102 moving to an inactive position.

While the controller 108 may perform similarity comparison operations as described above, in some embodiments the analysis may be performed by a separate device or component, with the similarity score communicated to the controller.

After determining whether the audio data satisfies the condition, the camera assembly 100 may perform an action related to the movable component 102 and/or the triggering mechanism 104. For instance, if it was determined that the movable component 102 did not move as intended, the action may involve causing the triggering mechanism 104 to further attempt to move the movable component 102. This may be effective in a situation where the movable component 102 was stuck in a minor way within the camera assembly 100, and another attempt may allow it to move freely as intended.

In some embodiments, the action may involve adjusting an operational parameter of the triggering mechanism 104. Additionally, the action may also involve, after adjusting the operational parameter, causing the triggering mechanism 104 to further attempt to move the movable component 102. In some embodiments, the triggering mechanism 104 may be an electromagnet, and adjusting the operational parameter may include adjusting the power of the electromagnet. For example, the power of the electromagnet may be increased on the further attempt in order to move the movable component 102 in a situation where it failed to move on the first attempt.

In some embodiments, the action may involve causing an alert to be provided to a user. Such an alert may indicate that the triggering mechanism's attempt to move the movable component 102 was unsuccessful. This alert may occur in response to the analysis of the audio data determining that the movable component 102 did not move. The alert may in some embodiments indicate that the triggering mechanism's attempt to move the movable component was successful, which could occur in response to the analysis of the audio data determining that the movable component did, in fact, move. In some embodiments, the alert may be communicated to an external system through the controller 108, or involve lighting an LED connected to the camera assembly 100.

In some embodiments, the action may involve updating a log to indicate that the triggering mechanism's attempt to move the movable component 102 was unsuccessful. Such a log may be stored within the controller 108, or transmitted to an external system or other component connected to the camera assembly 100.

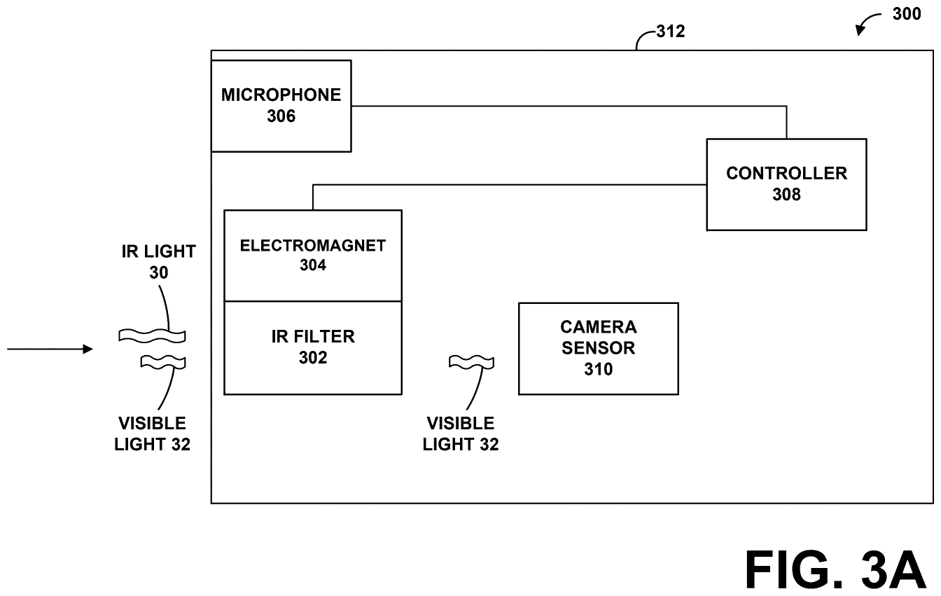

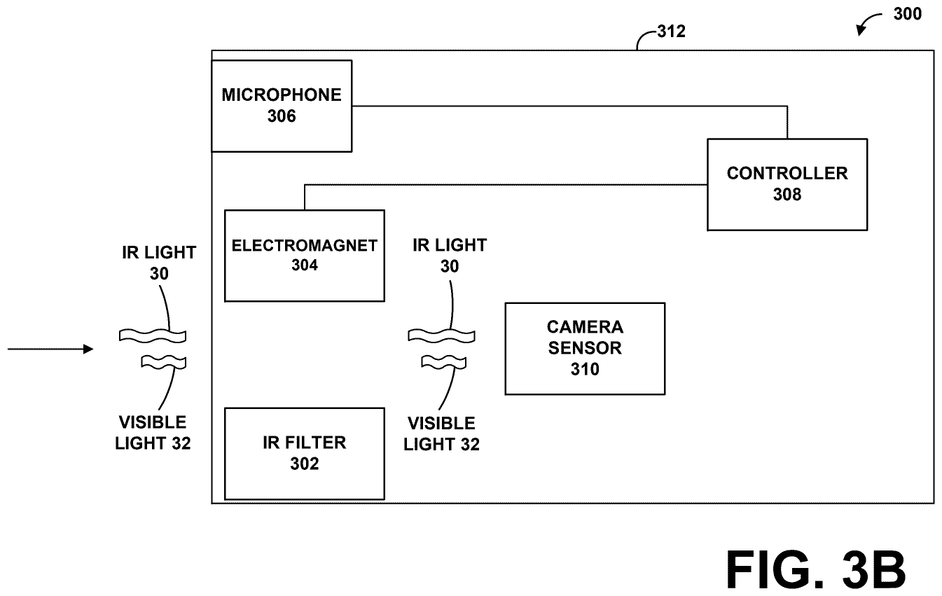

FIG. 3A depicts an example configuration 300 of the camera assembly 100, including an IR filter 302, electromagnet 304, microphone 306, controller 308, and camera sensor 310. The components in FIG. 3A are additionally located within a housing 312.

In this embodiment, the IR filter 302 is an example of a movable component 102 and the electromagnet 304 is an example of a triggering mechanism 104.

In FIG. 3A, the camera assembly configuration 300 is in a state where the electromagnet 304 has attracted the IR filter 302 into position within the camera assembly configuration 300. This may occur due to the electromagnet 304 receiving a pulse of electricity from the controller 308, which caused the IR filter 302 to be attracted to it. However, camera assembly configuration 300 can be mechanically stable. That is, the IR filter (or other movable component) can remain in place even after the electromagnet is no longer energized by the pulse of electricity. As depicted, IR light 30 and visible light 32 are travelling towards the camera sensor 310, but the IR filter 302 (in this example an IR-blocking filter) only permits visible light 32 to pass while blocking IR light 30. This may occur in the context of daytime operation of the camera assembly, where allowing IR light to the camera sensor could cause a red hue or other distortion to occur in the captured image.

FIG. 3B depicts the same example configuration 300 of the camera assembly 100, including an IR filter 302, electromagnet 304, microphone 306, controller 308, and camera sensor 310. As in FIG. 3A, the components in FIG. 3B are additionally located within a housing 312.

In this example, the electromagnet 304 has repelled (or has not yet attracted) the IR filter 302. In some embodiments, this may have occurred in response to an action of the controller 308, for instance a pulse of electricity that causes the electromagnet to have an opposite polarity from when the electromagnet attracted the IR filter 302. In response to this, the IR filter 302 has dropped to an inactive position, and thus both IR light 30 and visible light 32 are permitted to pass to the camera sensor 310. This may occur in the context of nighttime operation of the camera assembly, where the camera sensor 310 needs as much light as possible to produce images. As noted above, making use of IR light has a variety of applications, including thermal imaging. As noted above, since the camera assembly configuration 300 can be mechanically stable, the IR filter 302 can remain in place until the electromagnet 304 is again activated or otherwise energized.

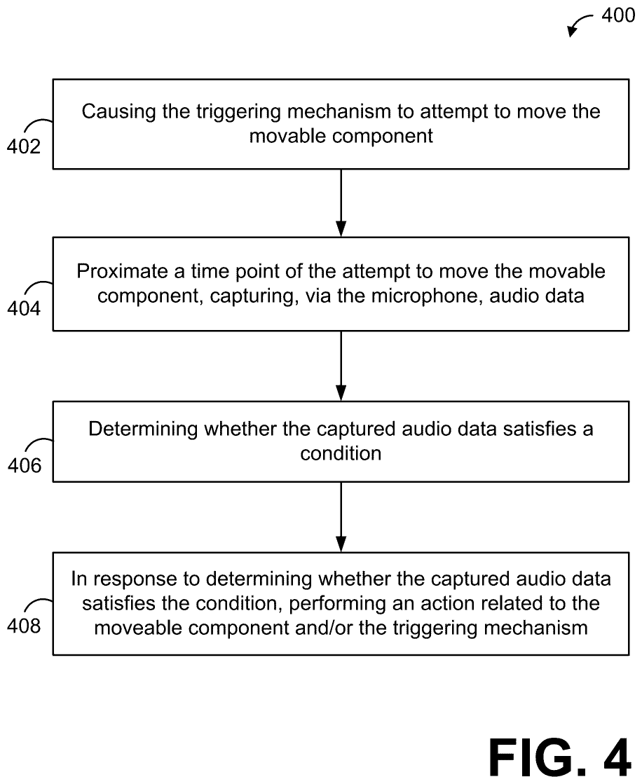

FIG. 4 is a flow chart illustrating an example method 400, which may be used with a camera assembly comprising a movable component, a triggering mechanism, and a microphone. At block 402, the method 400 involves causing the triggering mechanism to attempt to move the movable component. At block 404, the method 400 involves proximate a time point of the attempt to move the movable component, capturing, via the microphone, audio data. At block 406, the method 400 involves determining whether the captured audio data satisfies a condition. At block 408, the method 400 involves in response to determining whether the captured audio data satisfies the condition, performing an action related to the moveable component and/or the triggering mechanism.

In some embodiments, the camera assembly further comprises a housing, and wherein the movable component and the triggering mechanism are mounted to the housing.

In some embodiments, wherein the triggering mechanism comprises an electromagnet configured to cause movement of the movable component between an active position and an inactive position.

In some embodiments, the movable component comprises an infrared filter.

In some embodiments, causing the triggering mechanism to attempt to move the movable component occurs in response to determining whether a light level of a surrounding area of the camera assembly satisfied a condition.

In some embodiments, causing the triggering mechanism to attempt to move the movable component occurs in response to determining whether a time of day satisfies a condition.

In some embodiments, causing the triggering mechanism to attempt to move the movable component occurs in response to determining whether a particular geographic location of the camera assembly satisfies a condition.

In some embodiments, capturing, via the microphone, audio data occurs responsive to causing the triggering mechanism to attempt to move the movable component, and wherein the capturing occurs for a predetermined duration. In some embodiments, the predetermined duration is 100 to 200 milliseconds.

In some embodiments, determining whether the captured audio data satisfies a condition comprises (i) determining that an audio volume of the captured audio data does not exceed a predetermined threshold of audio volume, or (ii) determining that the captured audio data does not exceed a predetermined threshold extent of similarity to reference audio data. In some embodiments, determining that the audio data does not exceed a predetermined threshold extent of similarity to reference audio data comprises providing the captured audio data to a trained machine-learning model, wherein the trained machine-learning model is configured to receive input audio data, generate a similarity score relating to a degree of similarity between the received input audio data and reference audio data, and output the generated similarity score, responsive to the providing, receiving, from the trained machine-learning model, a corresponding similarity score, and using the received similarity score to determine that the captured audio data does not exceed the predetermining threshold extent of similarity to the reference audio data. In some embodiments, the action comprises updating a log to indicate that the triggering mechanism's attempt to move the movable component was unsuccessful.

In some embodiments, the action comprises causing the triggering mechanism to further attempt to move the movable component.

In some embodiments, the action comprises (i) adjusting an operational parameter of the triggering mechanism, and (ii) after adjusting the operational parameter of the triggering mechanism, causing the triggering mechanism to further attempt to move the movable component. In some embodiments, the triggering mechanism is an electromagnet, and adjusting the operational parameter of the triggering mechanism comprises increasing power of the electromagnet. In some embodiments the action comprises causing an alert to be provided to a user. In some embodiments, the alert indicates that the triggering mechanism's attempt to move the movable component was unsuccessful.

In some embodiments, determining whether the captured audio data satisfies a condition comprises (i) determining that an audio volume of the captured audio data exceeds a predetermined threshold of audio volume, or (ii) determining that the captured audio data exceeds a predetermined threshold extent of similarity to reference audio data.

In some embodiments, the action comprises updating a log to indicate that the triggering mechanism's attempt to move the movable component was successful.

In some embodiments, the operations of method 400 may be performed by a controller of a camera assembly. In some embodiments, the operations of method 400 may be caused by execution by a processor of program instructions stored on a non-transitory computer-readable medium.

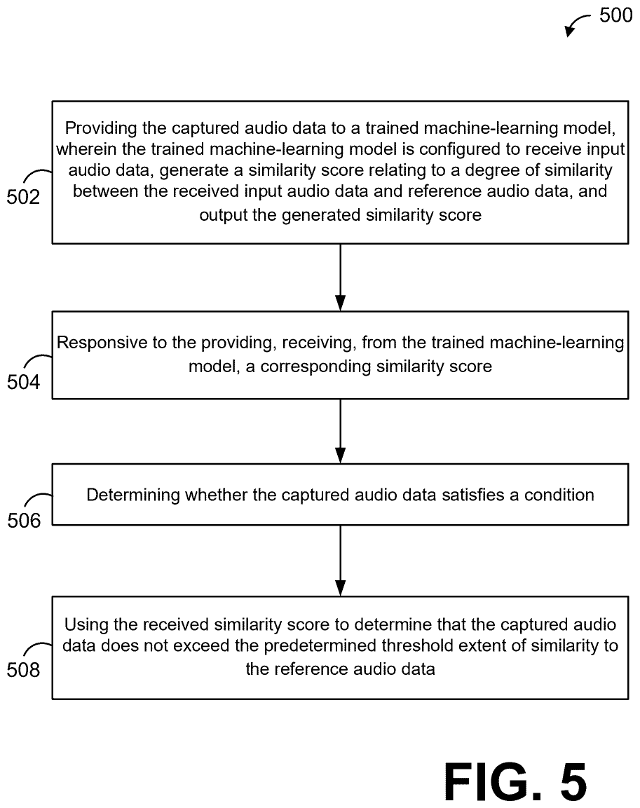

FIG. 5 is a flow chart illustrating an example method 500, which is an example technique of determining that the captured audio data does not exceed a predetermined threshold extent of similarity to reference audio data. At block 502, the method 500 involves providing the captured audio data to a trained machine-learning model, wherein the trained machine-learning model is configured to receive input audio data, generate a similarity score relating to a degree of similarity between the received input audio data and reference audio data, and output the generated similarity score. At block 504, the method involves responsive to the providing, receiving, from the trained machine-learning model, a corresponding similarity score. At block 506, the method involves using the received similarity score to determine that the captured audio data does not exceed the predetermining threshold extent of similarity to the reference audio data.

In some embodiments, the camera assembly 100 may include an accelerometer, which may be used to capture motion data. This can allow the camera assembly 100 to perform the same or similar operations to those described above, but by using motion data, rather than audio data, as a basis to perform one or more actions.

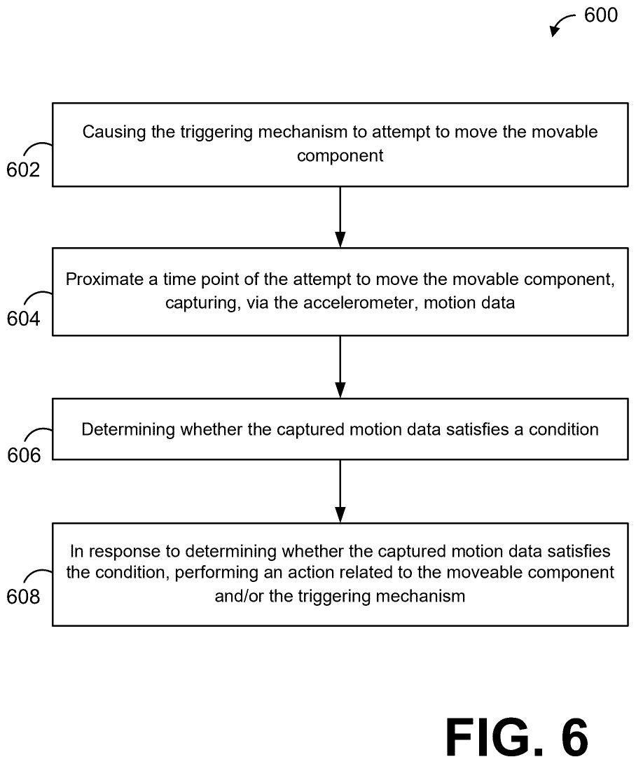

FIG. 6 is a flow chart illustrating an example method 600, which may be used with a camera assembly comprising a movable component, a triggering mechanism, and an accelerometer. At block 602, the method 600 involves causing the triggering mechanism to attempt to move the movable component. At block 604, the method 600 involves, proximate a time point of the attempt to move the movable component, capturing, via the accelerometer, motion data. At block 606, the method 600 involves determining whether the motion data satisfies a condition. At block 608, the method 600 involves in response to determining whether the motion data satisfies the condition, performing an action related to the moveable component and/or the triggering mechanism.

In some embodiments, capturing, via the accelerometer, motion data occurs responsive to causing the triggering mechanism to attempt to move the movable component, and wherein the capturing occurs for a predetermined duration. In some embodiments, the predetermined duration is 100 to 200 milliseconds.

In some embodiments, determining whether the motion data satisfies a condition comprises determining that the motion data does not exceed a predetermined threshold extent of similarity to reference motion data. In some embodiments, determining that the motion data does not exceed a predetermined threshold extent of similarity to reference motion data comprises providing the motion data to a trained machine-learning model, wherein the trained machine-learning model is configured to receive input motion data, generate a similarity score relating to a degree of similarity between the received input motion data and reference motion data, and output the generated similarity score, responsive to the providing, receiving, from the trained machine-learning model, a corresponding similarity score, and using the received similarity score to determine that the motion data does not exceed the predetermining threshold extent of similarity to the reference motion data. In some embodiments, the action comprises updating a log to indicate that the triggering mechanism's attempt to move the movable component was unsuccessful.

In some embodiments, determining whether the motion data satisfies a condition comprises (i) determining that the motion data exceeds a predetermined threshold of audio volume, or (ii) determining that the motion data exceeds a predetermined threshold extent of similarity to reference motion data.

### IV. Example Variations

Although some of the acts and/or functions described in this disclosure have been described as being performed by a particular entity, the acts and/or functions can be performed by any entity, such as those entities described in this disclosure. For example, some or all operations can be performed sever-side and/or client-side. Further, although the acts and/or functions have been recited in a particular order, the acts and/or functions need not be performed in the order recited. However, in some instances, it can be desired to perform the acts and/or functions in the order recited. Further, each of the acts and/or functions can be performed responsive to one or more of the other acts and/or functions. Also, not all of the acts and/or functions need to be performed to achieve one or more of the benefits provided by this disclosure, and therefore not all of the acts and/or functions are required.

Although certain variations have been discussed in connection with one or more examples of this disclosure, these variations can also be applied to all of the other examples of this disclosure as well.

Although select examples of this disclosure have been described, alterations and permutations of these examples will be apparent to those of ordinary skill in the art. Other changes, substitutions, and/or alterations are also possible without departing from the invention in its broader aspects as set forth in the following claims.

1. A method for use with a camera assembly comprising a movable component, a triggering mechanism, and a microphone, the method comprising:
causing the triggering mechanism to attempt to move the movable component;
proximate a time point of the attempt to move the movable component, capturing, via the microphone, audio data;
determining whether the captured audio data satisfies a condition; and
in response to determining whether the captured audio data satisfies the condition, performing an action related to the moveable component and/or the triggering mechanism.

2. The method of claim 1, wherein the camera assembly further comprises a housing, and wherein the movable component and the triggering mechanism are mounted to the housing.

3. The method of claim 1, wherein the triggering mechanism comprises an electromagnet configured to cause movement of the movable component between an active position and an inactive position.

4. The method of claim 1, wherein the movable component comprises an infrared filter.

5. The method of claim 1, wherein causing the triggering mechanism to attempt to move the movable component occurs in response to determining whether a light level of a surrounding area of the camera assembly satisfied a condition.

6. The method of claim 1, wherein causing the triggering mechanism to attempt to move the movable component occurs in response to determining whether a time of day satisfies a condition.

7. The method of claim 1, wherein causing the triggering mechanism to attempt to move the movable component occurs in response to determining whether a particular geographic location of the camera assembly satisfies a condition.

8. The method of claim 1, wherein capturing, via the microphone, audio data occurs responsive to causing the triggering mechanism to attempt to move the movable component, and wherein the capturing occurs for a predetermined duration.

9. The method of claim 8, wherein the predetermined duration is 100 to 200 milliseconds.

10. The method of claim 1, wherein determining whether the captured audio data satisfies a condition comprises (i) determining that an audio volume of the captured audio data does not exceed a predetermined threshold of audio volume, or (ii) determining that the captured audio data does not exceed a predetermined threshold extent of similarity to reference audio data.

11. The method of claim 10, wherein determining that the captured audio data does not exceed a predetermined threshold extent of similarity to reference audio data comprises:
providing the captured audio data to a trained machine-learning model, wherein the trained machine-learning model is configured to receive input audio data, generate a similarity score relating to a degree of similarity between the received input audio data and reference audio data, and output the generated similarity score;
responsive to the providing, receiving, from the trained machine-learning model, a corresponding similarity score; and
using the received similarity score to determine that the captured audio data does not exceed the predetermining threshold extent of similarity to the reference audio data.

12. The method of claim 1, wherein the action comprises causing the triggering mechanism to further attempt to move the movable component.

13. The method of claim 1, wherein the action comprises (i) adjusting an operational parameter of the triggering mechanism, and (ii) after adjusting the operational parameter of the triggering mechanism, causing the triggering mechanism to further attempt to move the movable component.

14. The method of claim 13, wherein the triggering mechanism is an electromagnet, and wherein adjusting the operational parameter of the triggering mechanism comprises increasing power of the electromagnet.

15. The method of claim 13, wherein the action comprises causing an alert to be provided to a user, wherein the alert indicates that the triggering mechanism's attempt to move the movable component was unsuccessful.

16. The method of claim 1, wherein the action comprises updating a log to indicate that the triggering mechanism's attempt to move the movable component was unsuccessful.

17. The method of claim 1, wherein determining whether the captured audio data satisfies a condition comprises (i) determining that an audio volume of the captured audio data exceeds a predetermined threshold of audio volume, or (ii) determining that the captured audio data exceeds a predetermined threshold extent of similarity to reference audio data.

18. The method of claim 17, wherein the action comprises updating a log to indicate that the triggering mechanism's attempt to move the movable component was successful.

19. A camera assembly comprising:
a movable component;
a triggering mechanism;
a microphone; and
a controller, wherein the controller is configured to perform a set of operations comprising:
causing the triggering mechanism to attempt to move the movable component;
proximate a time point of the attempt to move the movable component, capturing, via the microphone, audio data;
determining whether the captured audio data satisfies a condition; and
in response to determining whether the captured audio data satisfies the condition, performing an action related to the moveable component and/or the triggering mechanism.

20. A non-transitory computer-readable medium having stored thereon program instructions that upon execution by a processor cause performance of a set of operations comprising:
causing a triggering mechanism to attempt to move a movable component;
proximate a time point of the attempt to move the movable component, capturing, via a microphone, audio data;
determining whether the captured audio data satisfies a condition; and
in response to determining whether the captured audio data satisfies the condition, performing an action related to the moveable component and/or the triggering mechanism.
